(19) United States
(12) Patent Application Publication
(10) Pub. No.: US 2024/0163594 A1
(43) Pub. Date: May 16, 2024

(54) TELEVISION ARRANGEMENT

(71) Applicant: Frank HELD, Regensburg (DE)

(72) Inventor: Frank HELD, Regensburg (DE)

(21) Appl. No.: 18/280,448

(22) PCT Filed: Mar. 1, 2022
(86) PCT No.: PCT/EP2022/055184

§ 371 Date: Sep. 5, 2023

(30) Foreign Application Priority Data
Mar. 2, 2021 (DE) 10 2021 105 028.6

(51) Int. Cl. H04R 1/02

(52) U.S. Cl. CPC H04R 1/028; H04R 2499/15

(57) ABSTRACT

A television and/or picture display arrangement comprising includes a carrier, wherein a screen unit and a first loudspeaker unit are fixed to the carrier, wherein the first loudspeaker unit is an active loudspeaker unit such that the loudspeaker unit has an amplifier unit and at least one bass loudspeaker element and wherein the arrangement has two further loudspeaker units which are arranged on the carrier laterally next to the screen unit.

The present invention relates to a television or screen arrangement. Such arrangements are known from the prior art. TV sets known in the prior art usually have one or more loudspeakers in addition to the actual screen or display. Manufacturers usually attach great importance to the picture quality of the corresponding displays or screens, but sometimes neglect the sound quality of the loudspeakers. This is acceptable for a large number of film genres, for example, for a large number of feature films, but is disturbing or unacceptable for other formats such as concerts, especially live concerts.

Better sound quality would also be desirable in some other applications, for example in video games or computer animations.

The present invention is therefore based on the object of also improving the sound quality of such television sets or, more generally, picture display arrangements.

According to the invention, this is achieved by a television or picture display arrangement according to the independent patent claim. Advantageous embodiments and further developments are the subject of the subclaims.

A television arrangement according to the invention has a carrier, wherein a screen unit and a first loudspeaker unit are arranged or attached to the carrier and wherein the first loudspeaker unit is an active loudspeaker unit, such that the loudspeaker unit has an amplifier unit and at least one bass loudspeaker element. Furthermore, the television or picture display arrangement has at least two further loudspeaker units which are arranged on the carrier laterally next to the screen unit.

Therefore, according to the invention, a television or picture display arrangement is proposed which has an improved loudspeaker concept. Thus, a bass loudspeaker, in particular a subwoofer, is preferably arranged at the rear of the arrangement, wherein the entire loudspeaker arrangement also has an amplifier unit. In this way, the sound or audio output signal of the television unit or a television receiver can be used and processed into a satisfactory sound experience. It is also possible that the first loudspeaker unit is arranged in a space-saving way, for example at the rear of the television unit. This does not play a role with the classic subwoofer units, as the listener cannot locate the source of low-frequency sounds.

In a preferred embodiment, the carrier has a carrier element and the screen unit is arranged on a front side of this carrier element and the first loudspeaker unit is arranged on the rear side of this carrier element in such a way that the carrier element is arranged at least in sections between the screen unit and the first loudspeaker unit. In this way, even with higher weights of the screen unit and the first loudspeaker unit, the overall centre of gravity can be selected so that the arrangement stands stably, for example on a floor. It is possible that the first loudspeaker unit is arranged directly on the carrier, but it would also be conceivable that the loudspeaker unit is in turn arranged in a housing and this housing is arranged on the carrier.

Preferably, the screen unit is a flat screen unit and in particular an LED-based screen unit. This can be arranged on the carrier element by means of screws or bolts, for example. It is also possible that projections are formed on the carrier element, into which the screen unit is hooked. Preferably, the screen unit is arranged on the carrier device in a detachable or removable manner. Preferably, the first loudspeaker unit is also detachably arranged on the carrier.

Preferably, the amplifier unit also supplies the at least two further loudspeaker units. In a preferred embodiment, the two further loudspeaker units are of the same design.

In a further preferred embodiment, at least one of the two further loudspeaker units, and preferably both loudspeaker units, is movably arranged on the carrier in such a way that a distance between the two loudspeaker units can be changed. Preferably, these further loudspeaker units are movable in a direction which also lies in a plane formed by the screen. Preferably, the two loudspeaker units are arranged to be movable along a straight direction on the carrier. Preferably, however, a mechanical connection between the two further loudspeaker units and the support units (at least in a state mounted on the carrier units) remains.

A disadvantage of conventional TV sets is that although the loudspeakers are positioned on the side of the screen, this still means that the distance between the loudspeakers is relatively small. In this way, the stereo hearing sensation in particular can be impaired (in particular when the viewer is at a greater distance from the device). Said embodiment therefore proposes that the speakers remain arranged on the frame or carrier, but can be moved to greater distances from each other, so that the overall stereo listening experience can be improved.

In a further preferred embodiment, at least one of the two loudspeaker units is arranged on the carrier element or the carrier by means of a telescopic mechanism. Preferably, at least two and preferably at least two telescopic mechanisms are provided, by means of which at least one of the further speaker units is arranged on the carrier element. Preferably, the other further loudspeaker unit is also arranged on the carrier element by means of at least one telescopic element and preferably by means of at least two telescopic elements.

Preferably, the further loudspeaker units are midrange and/or tweeter units. Preferably, these further loudspeaker units are also supplied by the above-mentioned active amplifier unit. Preferably, these midrange/tweeter units have frequency ranges of 200 Hz-20,000 Hz. Preferably, the crossover frequencies are in the high-mid range of 70 Hz to 150 Hz.

In a further advantageous embodiment, the further loudspeaker units each have a weight which is between 400 g and 20 kg, preferably between 400 g and 4 kg. Preferably, the loudspeaker units each have a housing in which the respective loudspeaker elements are integrated.

In a further advantageous embodiment, the distance between the two further loudspeaker units can be changed or increased by at least 10 cm, preferably by at least 20 cm, preferably by at least 30 cm, preferably by at least 40 cm and preferably by at least 50 cm. Preferably, the distance can be increased by a maximum of 200 cm, preferably by a maximum of 180 cm and preferably by a maximum of 160 cm. In a further embodiment, it is also possible for the further loudspeaker units to be removed from the carrier and set up, for example, at other positions within a room.

In a further preferred embodiment, the further loudspeaker units are connected to the amplifier device by means of cable connections. These cable connections can, for example, be guided within the respective telescopic elements. Instead of the telescope described here, however, other fastenings are also conceivable, such as a scissor mechanism or the like.

In a further preferred embodiment, the carrier has a stand foot element. By means of this stand foot element, the carrier and in particular the television arrangement as a whole can be placed on a floor. In a further preferred embodiment, the stand foot element or several stand foot elements are arranged on a carrier in a removable manner. In this way, the carrier can be changed from floor mounting to wall mounting.

In a further preferred embodiment, the carrier is suitable and intended for direct mounting on a wall. For this purpose, holders or carrier elements can be provided, which on the one hand hold the amplifier unit on the carrier, but which on the other hand are suitable and intended for wall mounting. Thus, it would be possible that these carrier elements are first fixed to a wall, then the amplifier unit is fixed in these carrier elements and then, conversely, the carrier element holding the screen is arranged on these holding elements or these holders. The said carrier elements are in particular made of metal and in particular of stainless steel.

In a further preferred embodiment, the bass loudspeaker element and the amplifier unit are integrated into a common housing. It is also conceivable that several bass loudspeaker elements are integrated within this housing.

In a further preferred embodiment, the carrier element is a plate-like and/or frame-like element. In this frame-like element, both the amplifier unit and the screen unit can be fixed. In a further preferred embodiment, the carrier is made of a metal or a plastic. Particularly preferably, the carrier is made of stainless steel.

In a further preferred embodiment, the screen unit is pivotable with respect to at least one axis on the carrier. Thus, it is possible that the screen unit is pivotable about a vertical axis, but it would also be possible that the screen unit is pivotable about a horizontal axis. It is also possible for the screen unit to swivel around both a vertical and a horizontal axis. These axes can also be arranged on the carrier element.

A stereo arrangement with subwoofer is preferred. However, all Dolby Surround sounds, 3D sound, THX sound (in particular according to the THX standard), immersive sound and/or future arrangements that require several loudspeakers distributed in the room and/or on the arrangement are also possible, which thus preferably require several amplifier channels that can also be integrated. The arrangement can also have several audio inputs and thus replace the stereo system.

The subwoofer can contain 1-4 bass chassis and/or be designed as a closed, bass reflex, horn, bandpass or other housing concept.

The crossover frequencies in the high-mid range can range from 70 HZ to 150 HZ, those in the bass range also from 70 HZ to 150 HZ.

The power of the amplifier channels is preferably dependent on the price class and/or size. The power of the amplifier channels is preferably at least 10 watts and particularly preferably up to 1200 watts.

The size of the apparatus is offered in different ways. From computer monitors to very large TV sets.

Preferably, the arrangement has a width of at least 50 cm, preferably at least 70 cm, preferably at least 1 m, preferably at least 1.50 m. Preferably, the arrangement has a width of at most 3 m, preferably at most 2 m and particularly preferably at most 1.50 m. Preferably, the arrangement has a height of at least 30 cm, preferably at least 50 cm and particularly preferably at least 1 m. Preferably, the arrangement has a height of at most 2 m, preferably at most 1.5 m and particularly preferably at most 1 m.

Further advantageous embodiments can be seen in the attached drawings:

In the drawings:

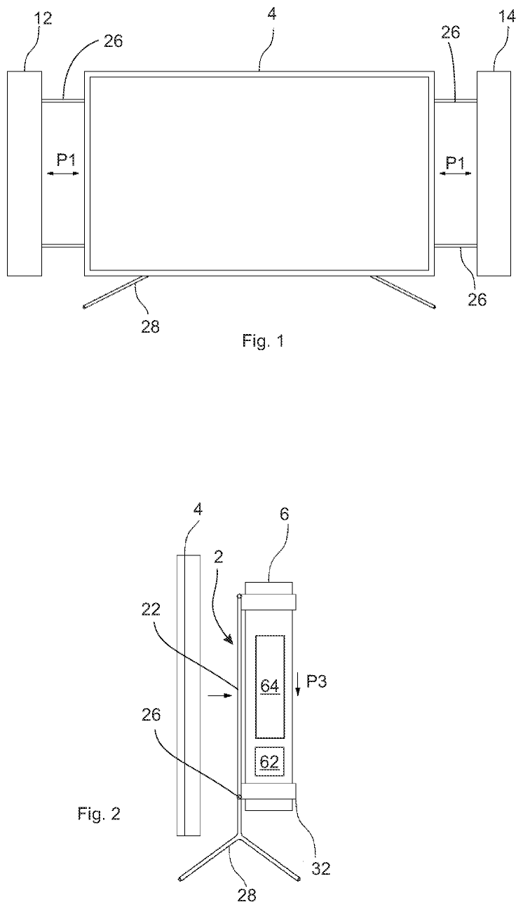

FIG. 1 shows a first representation of a television or screen arrangement according to the invention;

FIG. 2 shows a side view of the television or screen arrangement shown in FIG. 1.

FIG. 1 shows a television or screen arrangement 1 according to the invention. The reference sign 4 refers to a screen unit. Two further loudspeaker units 12 and 14 are arranged laterally on this screen unit. It can be seen that these can be moved with respect to the arrows P1, i.e. they can be moved closer to the screen unit or further away from it. To move these speaker units 12, 14, telescopic rod elements 26 are provided, which are arranged on the carrier (not shown in FIG. 1).

The reference sign 28 indicates a stand foot that is used to place the screen unit on the floor.

FIG. 2 shows a side view of the television arrangement shown in FIG. 1. Here the carrier element 2 or carrier 2 is provided, on which both the screen element 4 and the loudspeaker unit 6 are arranged. This loudspeaker unit 6 has loudspeaker elements 64 (shown only schematically) and an amplifier device 62. It is possible for the loudspeaker unit 6 to be suspended on the carrier 2. The reference sign 32 indicates holding clamps with which the loudspeaker unit 6 is hold on the carrier 2. These holding elements 32 can also be used to attach the amplifier unit or the entire television arrangement to a wall. In this case, the stand foot element 28 can be removed from the carrier 2. The telescopic elements 26, which serve for the movable arrangement of the (not shown) further loudspeakers, are preferably retractable in the carrier 2.

The applicant reserves the right to claim all features disclosed in the application documents as essential to the invention, provided that they are individually or in combination new compared to the prior art. It is further pointed out that the individual figures also describe features which may be advantageous in themselves. The skilled person immediately recognises that a certain feature described in a figure can also be advantageous without adopting further features from this figure. Furthermore, the skilled person recognises that advantages can also result from a combination of several features shown in individual figures or in different figures.

1-10. (canceled)

11. A television and/or picture display arrangement with a carrier, wherein a screen unit and a first loudspeaker unit are fastened to the carrier, wherein the first loudspeaker unit is an active loudspeaker unit in such a way that the loudspeaker unit has an amplifier unit and at least one bass loudspeaker element and wherein the arrangement has two further loudspeaker units which are arranged on the carrier laterally next to the screen unit.

12. The television and/or picture display arrangement according to claim 11, wherein the carrier comprises a carrier element and the screen unit is arranged at a front side of said carrier element and the first speaker unit is arranged at the rear side of said carrier element, such that the carrier element is arranged between the screen unit and the loudspeaker unit.

13. The television and/or picture display arrangement according to claim 11, wherein at least one of the two loudspeaker units is movably arranged on the carrier in such a way that a distance between the two further loudspeaker units can be varied.

14. The television and/or picture display arrangement according to claim 11, wherein at least one of the two loudspeaker units is arranged on the carrier using a telescopic mechanism.

15. The television and/or picture display arrangement according to claim 11, wherein the carrier comprises a stand foot element.

16. The television and/or picture display arrangement according to claim 11, wherein the carrier is configured for direct mounting on a wall.

17. The television and/or picture display arrangement according to claim 11, wherein the bass loudspeaker element and the amplifier unit are integrated in a common housing.

18. The television and/or picture display arrangement according to claim 11, wherein the carrier element is a plate-like or frame-like element.

19. The television and/or picture display arrangement according to claim 11, wherein the carrier is made of a metal or a plastic.

20. The television and/or picture display arrangement according to claim 11, wherein the screen unit is pivotably arranged on the carrier with respect to at least one axis.
